(19) United States
(12) Patent Application Publication
(10) Pub. No.: US 2015/0207879 A1
(43) Pub. Date: Jul. 23, 2015

(54) SYSTEMS AND METHODS FOR OPERATING AN APPLICATION DISTRIBUTION SYSTEM

(71) Applicant: CloudVolumes, Inc., Santa Clara, CA (US)

(72) Inventors: Matthew Conover, Mountain View, CA (US); Shaun Coleman, San Jose, CA (US)

(21) Appl. No.: 14/416,970

(22) PCT Filed: Jul. 24, 2013
(86) PCT No.: PCT/US13/51842

§ 371 Date: Jan. 23, 2015

Related U.S. Application Data
(60) Provisional application No. 61/674,981, filed on Jul. 24, 2012.

(51) Int. Cl. H04L 29/08; G06F 9/455; G06F 9/50

(52) U.S. Cl. CPC H04L 67/1097; G06F 9/5016; G06F 9/45558; G06F 2009/4557; G06F 2009/45579

(57) ABSTRACT

Embodiments disclosed herein provide systems and methods for distributing applications to virtual machines. In a particular embodiment, a method includes providing a list of one or more attachable applications and receiving a selection indicating at least one application of the one or more attachable applications to be attached to a virtual machine. The method further includes attaching the at least one application to the virtual machine.

### RELATED APPLICATIONS

This application hereby claims the benefit of and priority to U.S. Provisional Application No. 61/674,981, titled “SYSTEMS AND METHODS FOR OPERATING AN APPLICATION DISTRIBUTION SYSTEM,” filed Jul. 24, 2012, and PCT Application Number PCT/US2013/051842, titled “SYSTEMS AND METHODS FOR OPERATING AN APPLICATION DISTRIBUTION SYSTEM,” filed Jul. 24, 2013, which are hereby incorporated by reference in their entireties.

### TECHNICAL BACKGROUND

A “virtual machine” is a virtualized copy of a computer system, with virtual hardware (including disk controller, network card, etc.). Frequently, running within the virtual machine is a full operating system, such as Linux or Microsoft Windows. These virtual machines run on a physical host server known as the hypervisor. The hypervisor (such as Microsoft Hyper-V, Citrix XenServer, and VMware ESX Server) abstracts the physical hardware of the host server so that the virtual machine sees virtual hardware regardless of what the underlying hardware actually is.

The storage volumes that appear within the virtual machine are virtualized storage volumes provided by the hypervisor. The storage volumes visible from within the virtual machine can come from multiple sources including: (1) physical devices (such as a CD-ROM, a USB storage device, or a hard disk) directly mapped to the virtual machine, (2) SAN connected by iSCSI or Fibre Channel, (3) a file containing a virtual disk (such as the VHD file format used by Microsoft Hyper-V, the VMDK file format used by VMware ESX server, or the ISO file format used to represent optical discs such as CD or DVD). The storage devices may or may not be further partitioned into “partitions” (also known as disk partitions).

In addition, applications that were previously hosted within an enterprise are now being moved to “the cloud.” Cloud is a general term to describe use of dynamic computing resources provided by cloud hosting provider such as Rightscale and Amazon Web Services. Instead of using a virtual machine within the company's data center, a virtual machine can be provisioned from “the cloud” meaning that a new virtual machine can be provisioned within the cloud hosting provider's data center.

With existing cloud solutions such as Amazon Web Services, a customer would look for an existing virtual machine that has the software pre-installed. If a virtual machine with the software the customer needs is unavailable, the customer will need to create its own virtual machine and install the necessary software.

### OVERVIEW

Embodiments disclosed herein provide systems and methods for distributing applications to virtual machines. In a particular embodiment, a method includes providing a list of one or more attachable applications and receiving a selection indicating at least one application of the one or more attachable applications to be attached to a virtual machine. The method further includes attaching the at least one application to the virtual machine.

In some embodiments, the method includes starting the virtual machine.

In some embodiments, the method provides that attaching the at least one application to the virtual machine comprises identifying at least one storage volume based on the at least one application and attaching the at least one storage volume to the virtual machine.

In some embodiments, the method includes, in the virtual machine, executing an application from the at least one storage volume.

In some embodiments, the method provides that attaching the at least one storage volume to the virtual machine comprises directing a hypervisor to attach the at least one storage volume to the virtual machine.

In some embodiments, the method includes overlaying content into the virtual machine, wherein the content makes the at least one application on the at least one storage volume available to the virtual machine.

In some embodiments, the method includes detecting a detach triggering event and, in response to the detach triggering event, detaching the at least one storage volume from the virtual machine.

In some embodiments, the method provides that a storage system, comprising the at least one storage volume, is located remotely from a host computer system, comprising the virtual machine, over a communication network.

In some embodiments, the method provides that the selection is received from a user.

In a further embodiment, a computer readable medium having instructions stored thereon for operating an application distribution system is provided. The instructions, when executed by the application distribution system, direct the application distribution system to provide a list of one or more attachable applications and receive a selection indicating at least one application of the one or more attachable applications to be attached to a virtual machine. The instructions further direct the system to attach the at least one application to the virtual machine.

In another embodiment, an application distribution system is provided. The application distributions system comprises a plurality of storage volumes comprising one or more attachable applications. The application distribution system further comprises a processing system configured to provide a list of the one or more attachable applications, receive a selection indicating at least one application of the one or more attachable applications to be attached to a virtual machine, and attach the at least one application to the virtual machine.

### BRIEF DESCRIPTION OF THE DRAWINGS

FIG. 1 illustrates an application store according to one example.

FIG. 2 illustrates the operation of the application store according to one example.

FIG. 3 illustrates an application store system according to one example.

### DESCRIPTION

Systems and methods are provided herein to make applications available within a virtual machine (VM) using an application distribution system (App Store). In at least one example, prior to starting the virtual machine, a user may be presented with an application such as a web server that lists one or more attachable applications. From these applications the user can select applications that they would like included in the new virtual machine. After the selection of applications, the VM manager will request a hypervisor to attach the appropriate storage volume containing the applications such that the applications will be available when the new virtual machine starts.

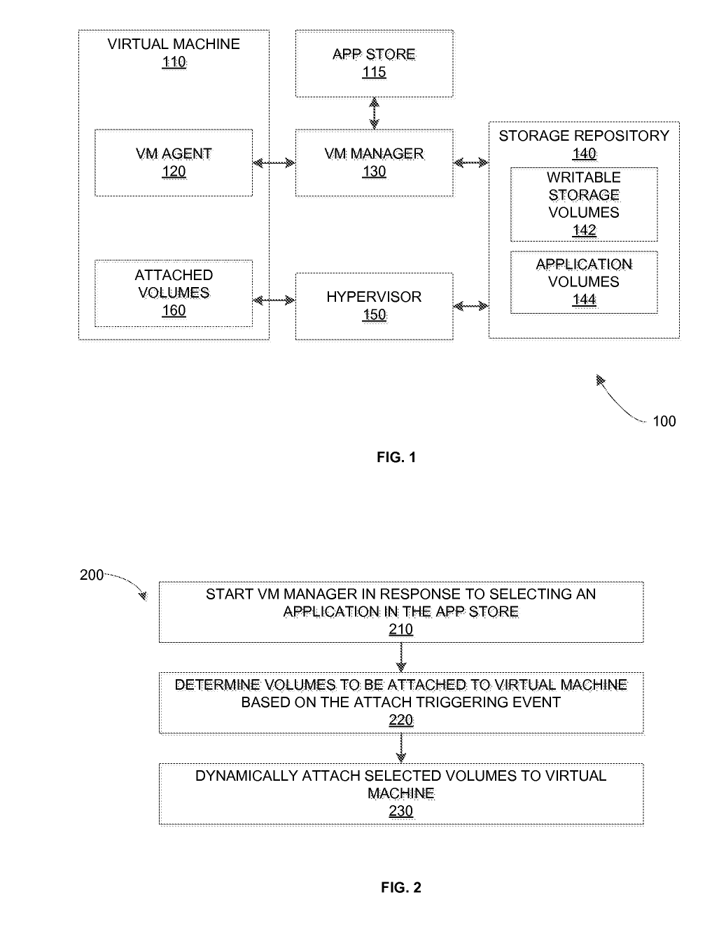

FIG. 1 illustrates a system 100 that includes virtual machine 110 consisting of VM agent 120 and attached volumes 160; App Store 115; VM manager 130; storage repository 140 consisting of writable storage volumes 142 and application volumes 144; and hypervisor 150.

System 100 is configured to start a virtual machine 110 with attached applications selected in App Store 115 using hypervisor-attached volumes. In particular, in at least one example, App Store 115 is configured to notify the VM manager 130 about applications to add to new virtual machine 110. In response, VM manager 130 determines which of various application volume(s) 144, should be attached to virtual machine 110. VM manager 130 then directs a request to hypervisor 150 to attach the selected application volume(s) 144 to the target virtual machine 110 such that the selected application volume(s) 144 will be attached when virtual machine 110 starts.

In one example, App Store 115 could include VM manager 130 such that App Store 115 determines the application volume(s) 144 to be attached to virtual machine 110 by the hypervisor 150.

Attached storage volumes 160 are shown within the target virtual machine 110 to emphasize the attachment of selected storage volumes 160, though it will be appreciated that selected storage volume 160 may not actually be transferred into target virtual machine 110.

FIG. 2 is a flowchart illustrating a method 200 of operating an App Store. As shown in FIG. 2, the method begins at step 210 by initiating a VM manager in response to detection of the user selecting an application in the App Store. Based on the selection, at step 220 volumes from a storage repository are identified. Thereafter, at step 230, the virtual machine is started with the selected application volumes attached.

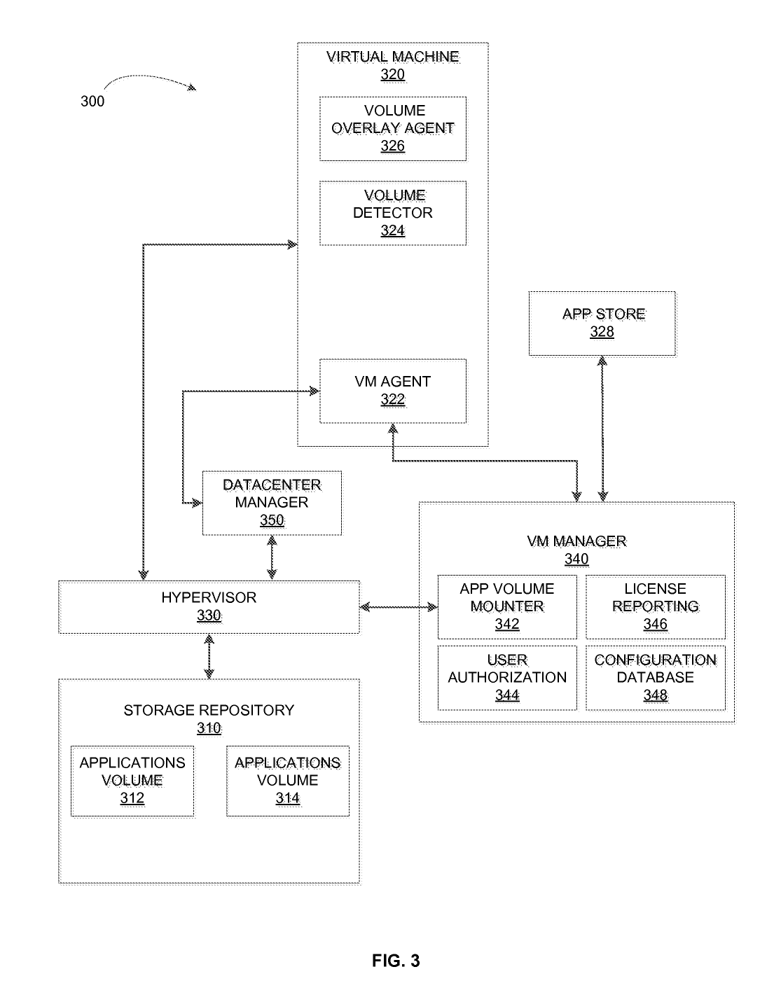

FIG. 3 illustrates a system 300 that includes storage repository 310 consisting of application volumes 312 and 314; virtual machine 320 consisting of volume overlay agent 326, volume detector 324, and VM Agent 322; App Store 328; hypervisor 330 executing the virtual machine; datacenter manager 350; and VM manager 340 consisting of app volume mounter 342, license reporting 346, user authorization 344, and configuration database 348.

In FIG. 3, App Store 328 is configured to allow users to select applications to attach to a new virtual machine 320. App Store 328 may present the user with a graphical interface including a list of available applications. The graphical interface could be on a web browser, another virtual machine, or any other method of displaying a list of applications prior to starting new virtual machine 320. In one example, a monetary amount could be attached to each of these applications, which could then be charged to the user based on the application selection. In another example, the applications could be free for the user to select. In another example, the applications could be a combination of paid applications and free applications.

Upon the user selecting an application or applications from App Store 328, VM manager 340 may determine the appropriate application volumes 312-314 to be attached to the virtual machine 320. In one example, App Store 328 may include VM manager 340 such that App Store 328 selects the appropriate application volumes 312-314. In other examples, VM manager 340 may reside on a separate physical computer or a separate virtual machine.

When the user selects an application from App Store 328, VM manager 340 will look for any application volumes, such as application volume 312. VM manager 340 can store this information in its internal memory, in a database (such as Configuration Database 348) or in a directory (such as “Active Directory”).

Once VM manager 340 has selected the relevant set of storage volumes based on the user application selection, VM manager 340 directly or indirectly contacts hypervisor 330 and requests the storage volumes to be attached to a new virtual machine 320 (the “target VM”). For example, VM manager 340 could directly request storage volumes 312-314 to be attached to the target VM by connecting to the hypervisor (such as VMware ESX server) or cloud infrastructure (such as Amazon EC2). VM manager 340 could indirectly request storage volumes 312-314 to be attached to the target virtual machine 320 by connecting to virtual datacenter manager 350 responsible for managing several hypervisors or cloud platforms. Further, load balancers and/or application brokers may be utilized with the system to help control and/or optimize the management of data by the system 300.

In at least one example, virtual machine 320 may include volume detector 324. Volume detector 324 can be configured to detect when a new storage volume has been attached to virtual machine 320. In one example, this can be a file system filter driver. In another example, this may be a file system mini-filter driver. In another example, this can be a Windows service configured to detect when new storage devices have been attached. Once a new storage volume has been detected, a volume overlay software agent will be invoked (“volume overlay agent 326”). This volume overlay agent may be part of volume detector 324 or may be a separate driver as shown. The volume overlay agent is responsible for exposing the applications contained in the storage volume and making it available to virtual machine 320.

Volume overlay agent 326 may accomplish this by overlaying the content (such as files and registry keys) into the VM so that the content can be seamlessly integrated into the VM. In addition, if one or more applications contained in a storage volume are meant to start automatically, then the VM agent can enumerate the contents of the volume and automatically start the relevant services or drivers. For example, the VM agent can enumerate all Start registry values to look for services contained in the

HKEY_LOCAL_MACHINE\SYSTEM\CurrentControlSet\Services subtree that should be automatically started and invoke the relevant APIs (such as ZwLoadDriver and StartService).

VM agent 322 is configured to respond automatically to storage volumes 312-314 as they are attached containing applications selected in App Store 328. VM agent 322, in various examples, could be a Windows service, a Unix daemon, or a script.

VM agent 322 may be configured to detach storage volumes upon detection of specific triggering events. These events could include the user shutting down the virtual machine, logging off the virtual machine, or any other event designated a detached triggering event. VM agent 322 may also be configured to detect the attached volumes and look for known load points, such as

### HKEY_LOCAL_MACHINE\CurrentControlSet\Services.

The storage attached to virtual machine 320 can be in any form supported by hypervisor 330 and the operating system of virtual machine 320. The storage attached to the virtual machine may contain multiple partitions, volumes, and file systems. Storage concepts such as partitions, volumes, and file systems are well-known to skilled artisans and outside the scope of this disclosure.

The storage attached to the virtual machine can be any type supported by the cloud infrastructure. In one example, the storage attached to the virtual machine can be attached through a network (using protocols such as iSCSI or Fibre Channel which reference storage by LUNs, or logical unit numbers). In another example, the storage attached to the virtual machine is directly attached from physical volumes (raw device mapping) such as a hard disk and hard disk partitions and the hypervisor with pass through access from the virtual machine directly to the hardware. In another example, the storage attached to the virtual machine can be a virtual device represented by a file (an ISO representing a virtual CD-ROM or a virtual hard disk file such as the VMDK and VHD file formats which represent a disk). In Amazon EC2 cloud, this may be an “elastic block storage”, in Microsoft Azure cloud this may be a “page blob.”

The storage attached to the virtual machine does not need to be contained within a single physical device or single virtual device represented by a file. The storage may be in the form of different virtual hard disk files or physical devices attached simultaneously which represent “physical volumes” within the virtual machine. These physical volumes will be composed of logical volumes. This approach, known as storage virtualization, allows logical volumes to be abstracted from the underlying physical storage. A logical volume (itself containing a file system) spread out across multiple physical volumes can lead to improved redundancy and performance where logical volumes. Technology to provide this storage virtualization, such as Redundant Array of Independent Disks (RAID for short), logical volumes, and physical volumes, are well-known to skilled artisans and outside the scope of this disclosure.

The above description and associated figures teach the best mode of the disclosure. The following claims specify the scope of the disclosure. Note that some aspects of the best mode may not fall within the scope of the disclosure as specified by the claims. Those skilled in the art will appreciate that the features described above can be combined in various ways to form multiple variations of the disclosure. As a result, the disclosure is not limited to the specific examples described above, but only by the following claims and their equivalents.

What is claimed is:

1. A method of operating an application distribution system, comprising:
providing a list of one or more attachable applications;
receiving a selection indicating at least one application of the one or more attachable applications to be attached to a virtual machine; and
attaching the at least one application to the virtual machine.

2. The method of claim 1, further comprising:
starting the virtual machine.

3. The method of claim 1, wherein attaching the at least one application to the virtual machine comprises:
identifying at least one storage volume based on the at least one application; and
attaching the at least one storage volume to the virtual machine.

4. The method of claim 3, further comprising:
in the virtual machine, executing an application from the at least one storage volume.

5. The method of claim 3, wherein attaching the at least one storage volume to the virtual machine comprises:
directing a hypervisor to attach the at least one storage volume to the virtual machine.

6. The method of claim 3, further comprising:
overlaying content into the virtual machine, wherein the content makes the at least one application on the at least one storage volume available to the virtual machine.

7. The method of claim 3, further comprising:
detecting a detach triggering event; and
in response to the detach triggering event, detaching the at least one storage volume from the virtual machine.

8. The method of claim 1, wherein a storage system, comprising the at least one storage volume, is located remotely from a host computer system, comprising the virtual machine, over a communication network.

9. The method of claim 1, wherein the selection is received from a user.

10. A computer readable medium having instructions stored thereon for operating an application distribution system, wherein the instructions, when executed by the application distribution system, direct the application distribution system to:
provide a list of one or more attachable applications;
receive a selection indicating at least one application of the one or more attachable applications to be attached to a virtual machine; and
attach the at least one application to the virtual machine.

11. The computer readable medium of claim 10, wherein the instructions further direct the application distribution system to:
start the virtual machine.

12. The computer readable medium of claim 10, wherein the instructions that direct the application distribution system to attach the at least one application to the virtual machine comprise instructions that direct the application distribution system to:
identify at least one storage volume based on the at least one application; and
attach the at least one storage volume to the virtual machine.

13. The computer readable medium of claim 12, wherein the virtual machine executes an application from the at least one storage volume.

14. The computer readable medium of claim 12, wherein the instructions that direct the application distribution system to attach the at least one storage volume to the virtual machine comprise instructions that direct the application distribution system to:
direct a hypervisor to attach the at least one storage volume to the virtual machine.

15. The computer readable medium of claim 12, wherein content is overlaid into the virtual machine and wherein the content makes the at least one application on the at least one storage volume available to the virtual machine.

16. The computer readable medium of claim 12, the instructions further direct the application distribution system to:
detect a detach triggering event; and
in response to the detach triggering event, detach the at least one storage volume from the virtual machine.

17. The computer readable medium of claim 10, wherein a storage system, comprising the at least one storage volume, is located remotely from a host computer system, comprising the virtual machine, over a communication network.

18. The computer readable medium of claim 10, wherein the selection is received from a user.

19. An application distribution system, comprising:
a plurality of storage volumes comprising one or more attachable applications;
a processing system configured to provide a list of the one or more attachable applications, receive a selection indicating at least one application of the one or more attachable applications to be attached to a virtual machine, and attach the at least one application to the virtual machine.

20. The application distribution system of claim 19, further comprising:
a host computer configured to start the virtual machine.
